(19) United States
(12) Patent Application Publication
(10) Pub. No.: US 2015/0132568 A1
(43) Pub. Date: May 14, 2015

(54) POLYMERIC POSITIVE TEMPERATURE COEFFICIENT THERMISTOR

(71) Applicant: Thinking Electronic Industrial Co., Ltd., Kaohsiung (TW)

(72) Inventor: Hai-Feng WANG, Kaohsiung (TW)

(21) Appl. No.: 14/300,816

(22) Filed: Jun. 10, 2014

(30) Foreign Application Priority Data
Nov. 13, 2013 (CN) 201310565449.8

(51) Int. Cl. H01C 7/02; H01C 7/00

(52) U.S. Cl. CPC H01C 7/027; H01C 7/008
USPC 428/328

(57) ABSTRACT

A polymeric positive temperature coefficient thermistor comprises a positive temperature coefficient complex material as a middle layer and an electrode covering a surface of the positive temperature coefficient complex material. The positive temperature coefficient complex material comprises a crystalline polymer, a titanium carbide nanoparticle powder, and a titanium carbide microparticle powder. A mass ratio of the titanium carbide nanoparticle powder to the titanium carbide microparticle powder ranges from 0.1:9.9 to 1.0:9.90. The titanium carbide nanoparticle powder comprises titanium carbide nanoparticles and a particle size of the titanium carbide nanoparticles is from 1 to 50 nm. The titanium carbide microparticle powder comprises titanium carbide microparticles and a particle size of the titanium carbide microparticles is from 0.1 to 10 μm.

### CROSS-REFERENCE TO RELATED APPLICATION

Pursuant to 35 U.S.C. §119(a), this application claims the benefit of the priority to China Patent Application No. 201310565449.8, filed Nov. 13, 2013. The content of the prior application is incorporated herein by its entirety.

### BACKGROUND OF THE INVENTION

1. Field of the Invention

The invention relates to a polymeric positive temperature coefficient thermistor, especially to a polymeric positive temperature coefficient thermistor comprising titanium carbide nanoparticles.

2. Description of the Prior Arts

Positive temperature coefficient thermistor (PTC thermistor) is a kind of electronic components widely applied to the field of over-current protection. At room temperature, a circuit comprising the positive temperature coefficient thermistor operates normally because the positive temperature coefficient thermistor has a low level resistance. When the circuit encounters an error situation, the temperature of the circuit as well as the temperature of the positive temperature coefficient thermistor will be increased by an abnormal high current of the circuit; in the meanwhile, the resistance of the positive temperature coefficient thermistor will be increased to prevent the circuit from burnout. When the error situation is eliminated, the temperature of the circuit is restored to room temperature, and the resistance of the positive temperature coefficient thermistor also returns to low-level condition, allowing the circuit to operate normally.

A polymeric positive temperature coefficient thermistor (PPTC thermistor) is a kind of the positive temperature coefficient thermistor. A common polymeric positive temperature coefficient thermistor is prepared from mixing a crystalline polymer with a nickel powder to form a nickel-based polymeric positive temperature coefficient thermistor. A resistance of the nickel-based polymeric positive temperature coefficient thermistor is about 20 mOhm; and a maximum voltage of the resistance of the nickel-based polymeric positive temperature coefficient thermistor is about 6 volts (V). However, the nickel powder of the nickel-based polymeric positive temperature coefficient thermistor is easily oxidized by air, causing the increment of the resistance of the nickel-based polymeric positive temperature coefficient thermistor. Furthermore, a high temperature cycle is defined as starting from room temperature to a high temperature and then going back to room temperature. When the nickel-based polymeric positive temperature coefficient thermistor experiences the high temperature cycle, the resistance of the nickel-based polymeric positive temperature coefficient thermistor cannot restore to its original value measured before the high temperature cycle. In other words, the nickel-based polymeric positive temperature coefficient thermistor has poor resistance-reproducibility after the high temperature cycle.

### SUMMARY OF THE INVENTION

The present invention provides a polymeric positive temperature coefficient thermistor comprising a positive temperature coefficient complex material (PTCCM) as a middle layer and an electrode covering a surface of the PTCCM, the PTCCM comprising:
crystalline polymer;
titanium carbide nanoparticle powder (TiC NP powder);
titanium carbide microparticle powder (TiC MP powder);
wherein a mass ratio of the TiC NP powder to the TiC MP powder is from 0.1:9.9 to 1.0:9.9;
the TiC NP powder comprises titanium carbide nanoparticles (TiC NPs) and a particle size of the TiC NPs is from 1 to 50 nanometers (nm); the titanium carbide microparticle powder comprises titanium carbide microparticles (TiC MPs), and a particle size of the TiC MPs is from 0.1 to 10 micrometers (μm).

The polymeric positive temperature coefficient thermistor of the present invention comprises the titanium carbide nanoparticles and the titanium carbide microparticles that retain the polymeric positive temperature coefficient thermistor stable after a high temperature cycle, such that the polymeric positive temperature coefficient thermistor has better resistance-reproducibility.

Preferably, the crystalline polymer comprises high density polyethylene, low density polyethylene, or the combination thereof

Preferably, a rate of resistance change (RoRC) of the polymeric positive temperature coefficient thermistor after the high temperature cycle is less than 2.

Preferably, the electrode is a titanium carbide-nickel composite coating copper foil; the titanium carbide-nickel composite coating copper foil comprises a copper foil and a titanium carbide-nickel composite coating layer coated on the copper foil and ; the titanium carbide-nickel composite coating layer comprises titanium carbide particles (TiC particles); a particle size of the TiC particles is from 1 to 50 nm.

Preferably, a nanoscale force is formed between the positive temperature coefficient complex material and the titanium carbide particles.

Preferably, a hardness, coefficient of thermal expansion, and conductivity of the titanium carbide particles of the titanium carbide-nickel composite coating layer is the same as the titanium carbide nanoparticles of the titanium carbide nanoparticle powder. The titanium carbide particles can effectively reduce the degree of coefficient of thermal expansion mismatch between the PTCCM and the electrode.

Other objectives, advantages and novel features of the invention will become more apparent from the following detailed description when taken in conjunction with the accompanying tables.

### DETAILED DESCRIPTION OF THE PREFERRED EMBODIMENTS

The present invention was further illustrated by the following examples; it should be understood that the examples and embodiments described herein are for illustrative purposes only and should not be construed as limiting the embodiments set forth herein.

### Embodiment 1

A method for preparing a polymeric positive temperature coefficient thermistor is described as follows.

A crystalline polymer, a titanium carbide nanoparticle powder, and a titanium carbide microparticle powder are mixed at 180 degrees Celsius (° C.) to form a positive temperature coefficient complex material. The positive temperature coefficient complex material, as a middle layer, is then pressed by an electrode into a panel of 0.4 millimeter (mm) in thickness. The panel is cut into a chip size of 3×5 mm² in area to form the positive temperature coefficient thermistor. The crystalline polymer comprises high density polyethylene, low density polyethylene, or the combination thereof.

A mass ratio of the titanium carbide nanoparticle powder to the titanium carbide microparticle powder is 0.1 to 9.90.

The titanium carbide nanoparticle powder comprises titanium carbide nanoparticles and a particle size of the titanium carbide nanoparticles is 40 nm.

The titanium carbide microparticle powder comprises titanium carbide microparticles and a particle size of the titanium carbide microparticles is 5 μm.

The electrode is a titanium carbide-nickel composite coating copper foil. The titanium carbide-nickel composite coating copper foil comprises a copper foil and a titanium carbide-nickel composite coating layer formed by ion sputtering and coated on the copper foil. The titanium carbide-nickel composite coating layer comprises titanium carbide particles. A particle size of the titanium carbide particles of the titanium carbide-nickel composite coating layer is 1 nm. A hardness, coefficient of thermal expansion, and a conductivity of the titanium carbide particles of the titanium carbide-nickel composite coating layer is the same as the titanium carbide nanoparticles of the titanium carbide nanoparticle powder.

### Embodiment 2

The method for preparing the polymeric positive temperature coefficient thermistor is similar to the method described in the Embodiment 1. The difference between the Embodiment 2 and the Embodiment 1 is that the mass ratio of the titanium carbide nanoparticle powder to the titanium carbide microparticle powder used in the Embodiment 2 is 0.50 to 9.50.

### Embodiment 3

The method for preparing the polymeric positive temperature coefficient thermistor is similar to the method described in the Embodiment 1. The difference between the Embodiment 3 and the Embodiment 1 is that the mass ratio of the titanium carbide nanoparticle powder to the titanium carbide microparticle powder used in the Embodiment 3 is 1.00 to 9.00.

### Comparative Embodiment 1

The method for preparing the polymeric positive temperature coefficient thermistor is similar to the method described in the Embodiment 1. The difference between Comparative embodiment 1 and Embodiment 1 is that the positive temperature coefficient complex material is mixed from the crystalline polymer and the titanium carbide microparticle powder, but not from the titanium carbide nanoparticle powder. In other words, the mass ratio of the titanium carbide nanoparticle powder to the titanium carbide microparticle powder used in the Embodiment 4 is 0.00 to 10.00.

### Comparative Embodiment 2

The method for preparing the polymeric positive temperature coefficient thermistor is similar to the method as described in Embodiment 1. The difference between the Comparative embodiment 2 and the Embodiment 1 is that the positive temperature coefficient complex material is mixed from the crystalline polymer and a nickel powder under high temperature condition about 180° C.

### Experimental Embodiment

A room temperature resistance (RTR) of the polymeric positive temperature coefficient thermistor is defined as a resistance value of the polymeric positive temperature coefficient thermistor measured at room temperature. The polymeric positive temperature coefficient thermistor is put into a standard reflux solder curve at 265° C. for 10 seconds, and then cooled down to room temperature for 1 hour, so as to experience a high temperature cycle. A heat-cycle resistance (HCR) of the polymeric positive temperature coefficient thermistor is defined as a resistance value of the polymeric positive temperature coefficient thermistor measured after the polymeric positive temperature coefficient thermistor experienced the high temperature cycle. A rate of resistance change (RoRC) of the polymeric positive temperature coefficient thermistor is obtained by dividing the HCR by the RTR. Values of the RTR, the HTR, and the RoRC of the polymeric positive temperature coefficient thermistor tested in each embodiment are listed in Table 1.

TABLE 1

| | | Mass ratio | | | |
|---|---|---|---|---|---|
| | | of TiC NP | | | |
| | | powder to | | | |
| | Nickel | TiC MP | | | |
| | powder | powder | RTR | HCR | RoRC |
| Unit | — | — | mOhm | mOhm | — |
| Embodiment 1 | — | 0.10:9.90 | 7.80 | 14.0 | 1.80 |
| Embodiment 2 | — | 0.50:9.50 | 5.30 | 8.0 | 1.50 |
| Embodiment 3 | — | 1.00:9.00 | 4.70 | 6.6 | 1.40 |
| Comparative | — | 0.00:10.0 | 8.20 | 20.5 | 2.50 |
| embodiment 1 | | | | | |
| Comparative | 10.0 | — | 5.0 | 250 | 50.0 |
| embodiment 2 | | | | | |

Comparing the Embodiments 1 to 3 with Comparative embodiment 1, with the increment of the mass ratio of the titanium carbide nanoparticle powder to the titanium carbide microparticle powder, the RoRC value will decrease. Comparing the Embodiments 1 to 3 with the Comparative embodiment 2, the excellent anti-thermal and anti-aging properties of the titanium carbide nanoparticles and the titanium carbide microparticles provide a lower rate of resistance change of the polymeric positive temperature coefficient thermistor in the Embodiment 1 to 3 than that in the Comparative embodiment 2. Therefore, the polymeric positive temperature coefficient thermistor prepared from the Embodiment 1 to 3 has better recovery capability and resistance reproducibility after the high temperature cycle, and also possesses high stability after multiple uses.

From the results, the titanium carbide nanoparticles have high strength, high hardness, low coefficient of thermal expansion, excellent conductivity, excellent thermal conductivity, and thermal stability properties for providing reduction of the resistance (comprising both of the temperature resistance and the heat-cycle resistance) of the polymeric positive temperature coefficient thermistor as mixed with the titanium carbide microparticles. Furthermore, an original particle density of the titanium carbide nanoparticles of the polymeric positive temperature coefficient thermistor retains normal value even after the high temperature cycle. Therefore, the polymeric positive temperature coefficient thermistor has lower rate of resistance change as the ratio of titanium carbide nanoparticle powder increases.

What is claimed is:

1. A polymeric positive temperature coefficient thermistor comprising:
a positive temperature coefficient complex material as a middle layer and an electrode covering a surface of the positive temperature coefficient complex material; the positive temperature coefficient complex material comprising:
crystalline polymer;
titanium carbide nanoparticle powder; and
titanium carbide microparticle powder;
wherein a mass ratio of the titanium carbide nanoparticle powder to the titanium carbide microparticle powder is from 0.1:9.9 to 1.0:9.9;
the titanium carbide nanoparticle powder comprises titanium carbide nanoparticles and a particle size of the titanium carbide nanoparticles ranges from 1 to 50 nanometers; and
the titanium carbide microparticle powder comprises titanium carbide microparticles and a particle size of the titanium carbide microparticles is from 0.1 to 10 micrometers.

2. The polymeric positive temperature coefficient thermistor as claimed in claim 1, wherein the crystalline polymer comprises high density polyethylene, low density polyethylene, or the combination thereof.

3. The polymeric positive temperature coefficient thermistor as claimed in claim 1, wherein a rate of resistance change of the polymeric positive temperature coefficient thermistor is less than 2.

4. The polymeric positive temperature coefficient thermistor as claimed in claim 1, wherein the electrode is a titanium carbide-nickel composite coating copper foil comprising a copper foil and a titanium carbide-nickel composite coating layer coated on the copper foil; the titanium carbide-nickel composite coating layer comprises titanium carbide particles; a particle size of the titanium carbide particles of the titanium carbide-nickel composite coating layer is from 1 to 50 nanometers.
